(19) United States
(12) Patent Application Publication
(10) Pub. No.: US 2008/0109619 A1
(43) Pub. Date: May 8, 2008

(54) INFORMATION PROVISION SYSTEM AND INFORMATION PROVISION METHOD

(76) Inventor: Masashi Nakanishi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/625,442

(22) Filed: Jan. 22, 2007

(30) Foreign Application Priority Data
Nov. 8, 2006 (JP) 2006-302186

(51) Int. Cl. G06F 12/00; G06F 7/00

(52) U.S. Cl. 711/159; 707/102; 711/E12.002; 707/E17.005

(57) ABSTRACT

Providing a highly convenient information provision system and an information provision method capable of improving the convenience of the information provision system. In this system, a communication device creates second address information by adding a desired restore point-in-time to first address information which indicates the location of access target information on a network, and sends it to the information providing server via the network. The information providing server restores the target information to its state as of at the designated restore point-in-time based on the received second address information and sends it to the communication device.

### CROSS-REFERENCES TO RELATED APPLICATIONS

This application relates to and claims priority from Japanese Patent Application No. 2006-302186, filed on Nov. 8, 2006, the entire disclosure of which is incorporated herein by reference.

### BACKGROUND

1. Field of the Invention

This invention relates to an information provision system and information provision method, and is suitable for application in a network system where clients used by users, web search servers provided by providers of web search services (hereinafter called ‘web search service providers’), and information providing servers provided by information providers are connected to one another via the Internet.

2. Description of Related Art

Data restore methods using snapshots have been used in storage apparatuses. These methods are used when data is lost by human errors or when it is desired that a file be restored to its state as of at the time its snapshot was created. Here a ‘snapshot’ refers to a data image of a logical volume as of at a certain point-in-time.

A data image of a logical volume created in this kind of data restore method is composed, not of the data of the overall logical volume as of at the time its snapshot was created, but of the data of the current logical volume and differential data, which is the data for differences between the logical volume as of at the time the snapshot was created and the current logical volume. Based on the differential data and the data in the current logical volume, the logical volume can be restored to the state as of at the time a snapshot creation request was made. Accordingly, this data restore method has an advantage in that the storage capacity required for storing the image as of at the time the snapshot was created is small, compared to the case where the data image of the entire logical volume is stored.

Japanese Patent Laid-Open Publication No. 2005-18738 proposes a method called CDP (Continuous Data Protection) using snapshots as well as journals, which are composed of update history information for logical volumes, as a data restore method for a storage apparatus.

In this data restore method, a snapshot of a logical volume is obtained and stored at regular time intervals while journals are accumulated in order; and, when restoring the logical volume to the state as of at a certain point-in-time (‘restore point-in-time’), the journals are applied in order, beginning with the oldest journal, to the snapshot whose acquisition time is prior but closest to the restore point-in-time, the journals having been obtained during the time from the snapshot acquisition time to the restore point-in-time. This data restore method has an advantage in that a logical volume can be restored to the state as of at an arbitrary point-in-time.

Recently, with the developments in information technology, computers have been used by many people and various kinds of information has been provided via networks such as the Internet. One of the methods widely used for obtaining desired information from among the enormous amount of information available is to access the site of a web search service provider and search for the desired information by specifying appropriate keywords on the displayed web search page.

Examples of web search engines currently used by web search service providers include robot-type search engines and directory-type search engines.

With a robot-type search engine, an information database is created by traveling from one web page to another using a search robot called a ‘crawler’ and collecting information. The robot-type search engine keeps traveling along the link structure of web pages and collects new information.

Here, the robot-type search engine collects, in addition to general web page data, information having various kinds of extensions such as documents, images, and voices.

The information collected in the above manner is stored in a search database with its collection date and time, keywords extracted from the file, URL (uniform resource locator), which is the address information for the site of the information on the Internet, and indexes.

This search database is updated regularly, for example, every day, once every few weeks, or once every few months. The information published on the Internet is collected by the robot-type search engine as long as a link to the information is provided on any web page and presented to the user as the result of a search using the keywords related to the information. Incidentally, to ‘provide a link’ is to indicate the URL (positional information) of information in a document.

The web search engines do not collect information on the Internet at all times or each time an information provider updates the information. In other words, a keyword search on a web search page is performed based on the information existing in the Internet when the web search engines collected the information, not based on the information currently existing on the Internet.

Therefore, there are some cases where an attempt to access a web page listed on a web search result screen is made but the access to that web page cannot be made. This is because, although the web page was on the Internet when the information was collected by a web search engine, the web page has been deleted since, and now is not on the Internet.

In the present circumstances, the user cannot see that web page any more. However, if a system enabling users to refer to the web pages that are no longer on the Internet is realized, the performance of the search improves for the user and the convenience of the Internet as an information provision system can be improved dramatically.

This invention has been made in light of these points and it is an object of this invention to provide a convenient information provision system, and an information provision method capable of improving the convenience of the information provision system.

### SUMMARY

In order to achieve the foregoing object, this invention provides an information provision system where a communication device and an information providing server that provides information in response to a request from the communication device are connected via a network. In this system, the communication device creates second address information by adding a desired restore point-in-time to first address information which indicates the location of access target information on the network, and sends it to the information providing server via the network. The information providing server restores, based on the received second address information, the target information to its state as of at the designated restore point-in-time and sends it to the communication device.

This invention also provides an information provision method for a network system where a communication device and an information providing server that provides information in response to a request from the communication device are connected to each other via a network. This method includes: a first step where the communication device creates second address information by adding a desired restore point-in-time to first address information which indicates the location of access target information on the network and sends it to the information providing server via the network; and a second step where the information providing server restores, based on the received second address information, the target information to its state as of at the designated restore point-in-time and sends it to the communication device.

This invention allows users to obtain information that has been deleted from the Internet, thereby improving the performance of the search for the users. Consequently, the convenience of an information provision system can be improved to a great extent.

### BRIEF DESCRIPTION OF THE DRAWINGS

FIG. 1 is a block diagram showing the overall structure of a network system according to Embodiments 1-3 of this invention.

FIG. 2 is a conceptual diagram explaining the CDP function.

FIG. 3 is a conceptual diagram explaining a journal backup function.

FIG. 4 is a conceptual diagram also explaining the journal backup function.

FIG. 5 is a diagram explaining the outline of a page restore function.

FIG. 6 is a diagram also explaining the outline concept of the page restore function.

FIG. 7 is a conceptual diagram showing the structure of a restore management table.

FIG. 8 is a conceptual diagram showing the structure of a history management table.

FIG. 9 is a conceptual diagram showing the structure of a volume management table.

FIG. 10 is a conceptual diagram explaining the relationships between the restore management table, history management table, and volume management table.

FIG. 11 is a diagram explaining the sequence of steps in the page restore process according to Embodiment 1 of this invention.

FIG. 12 is a diagram where (A) to (F) show, with dashed lines, the various screens presented to clients.

FIG. 13 is a diagram explaining the sequence of steps in the page restore process performed when a first restore mode is selected.

FIG. 14 is a diagram explaining the sequence of steps in the page restore process performed when a second restore mode is selected.

FIG. 15 is a flowchart showing the procedure of the first restore process.

FIG. 16 is a flowchart showing the procedure of the second restore process.

FIG. 17 is a diagram explaining the sequence of steps in the page restore process according to Embodiment 2 of this invention.

FIG. 18 is a diagram explaining the sequence of steps in the page restore process according to Embodiment 3 of this invention.

FIG. 19 is a flowchart showing the procedure of the pre-restore process according to Embodiment 3 of this invention.

### DETAILED DESCRIPTION OF PREFERRED EMBODIMENTS

Embodiments of this invention are described below with reference to the drawings.

### (1) Embodiment 1

### (1-1) Structure of Network system according to Embodiment 1

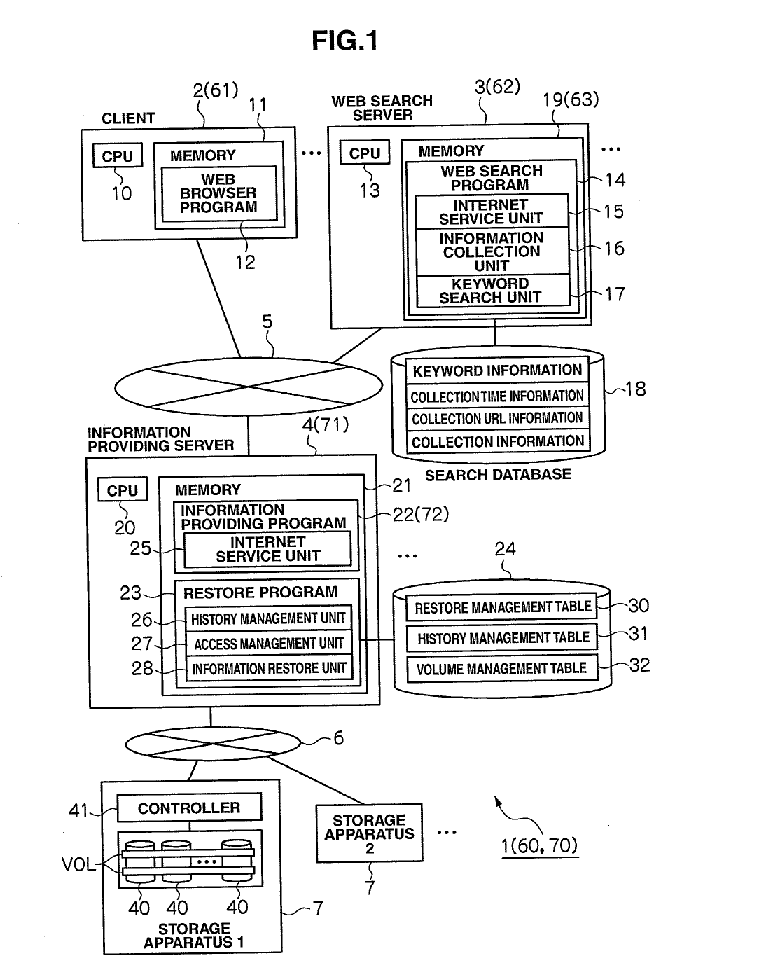

FIG. 1 shows the network system according to Embodiment 1. In this network system 1, clients 2, web search servers 3 and information providing servers 4 are connected to one another via a first network (‘the Internet’) and each information providing server 4 is connected to a plurality of storage apparatuses 7 via a second network 6, such as a SAN (Storage Area Network).

Each client 2 is a general personal computer used by a user and includes a CPU (Central Process Unit) 10, memory 11, input devices such as a mouse and keyboard (not shown in the drawing), and a display such as a liquid crystal panel or CRT (Cathode Ray-Tube).

The memory 11 in the client 2 stores a pre-installed web browser program 12 and the CPU 10 runs the web browser program 12 so that the client 2 can access, via the Internet 5, a web search site provided by a web search service provider 3 or a site provided by an information provider. With this program, the user can perform a keyword search on the web search site using arbitrary keywords, or obtain desired information on the site provided by the information provider.

Each web search server 3 is a computer provided by a web search service provider and includes hardware such as a CPU 13 and memory 14. The CPU 13 is a processor controlling the operations of the overall web search server 3. The memory 14 is used for storing various control programs and various information and also functions as a work memory for the CPU 13. The CPU 13 runs the control programs stored in the memory 14 so that the web search server 3 can executes various process.

In Embodiment 1, the memory 14 in the web search server 3 stores, as one of the control programs, a web search program 19 which is composed of an Internet service unit 15, information collection unit 16, keyword search unit 17, and search database 18.

The Internet service unit 15 is a program for providing the screen data of a web search page to a client 2 in response to a reference request from the client 2.

The information collection unit 16 is a program for collecting, using an independent information collecting robot, the information on the Internet 5 (i.e., various files, hereinafter called ‘files’) automatically and randomly. Files collected by the information collection unit 16 are associated with keywords and registered in the search database 18 with their collection times and the URLs of the web pages they were collected from.

The keyword search unit 17 is a program for searching (querying) the search database 18 based on the keywords input by a user and sent from his/her client 2. The result obtained in the search is sent to the client 2 via the Internet service unit 15.

Each information providing server 4 is a computer provided by an information provider and includes hardware such as a CPU 20 and memory 21. The CPU 20 is a processor controlling the operations of the overall information providing server 4. The memory 21 is used for storing various control programs and various information and also functions as a work memory for the CPU 20. The CPU 20 runs the control programs stored in the memory 21 so that the information providing server 4 can execute various processes.

In Embodiment 1, the memory 21 in the information providing server 4 stores, as its control programs, an information provision program 22, restore program 23, and management database 24.

The information provision program 22 is for providing various files—the screen data of web pages, documents, images and voices—stored in the information providing server 4 and storage apparatuses 7 to a client 2 or web search server 3, and is composed of an Internet service unit 25. Based on the Internet service unit 25, the information providing server 4 reads a necessary file from the information providing server 4 or storage apparatus 7 and sends it to the client 2 or web search server 3 in response to a reference request.

The restore program 23 is related to a page restore function, which will be described later, and is composed of a history management unit 26, access management unit 27 and information restore unit 28.

The history management unit 26 is for managing and monitoring the history of deletions and updates to the information (files) provided by information providers. The access management unit 27 is for managing whether or not a restore-target file can be restored or not. A restore management table 30, history management table 31, and volume management table 32 (explanations for the tables will be given later) used by the history management unit 26 and access management unit 27 are stored in the management database 24. The information restore unit 28 is for restoring, in response to an external request, a file provided by an information providing server 4 to its state as of at a designated restore point-in-time.

Each storage apparatus 7 is a large-capacity storage apparatus for storing files of the information the information providers put on the Internet 5. It is composed of: a plurality of disk devices 40 for providing storage areas for storing data; and a controller 41 for controlling these disk devices 40.

Each disk device 40 is, for example, an expensive disk such as an SCSI (Small Computer System Interface) disk or inexpensive disk such as a SATA (Serial AT Attachment) disk or optical disk. The disk devices 40 are managed by the controller 41 based on the RAID (Redundant Array of Inexpensive Disks) method. Incidentally, semiconductor memories, such as flash memories, may be used in place of the disk devices 40.

One or more logical volumes VOL are set for the physical storage areas provided by one or more disk devices 40. Data is read/written from/to the logical volumes VOL in units of blocks of a predetermined size.

Each logical volume VOL is assigned a unique volume ID (e.g., LUN (Logical Unit Number)). In Embodiment 1, access to the data stored in a storage apparatus 7 is made by designating an address, which is the combination of a volume ID and a block ID number (e.g., LBA (Logical Block Address)) uniquely assigned to each block in the volume.

Incidentally, examples of types of logical volumes VOLs created in the storage apparatuses 7 include data volumes, snapshot volumes, and journal volumes. Among these, data volumes are used for storing the files the information providers put on the Internet and the snapshot volumes are used for storing the differential data of created snapshots. Journal volumes are used for storing journals.

The controller 41 is structured including a network interface for communication with the information providing servers 4 via the network 6, a disk interface for communication with the respective disk devices 40, and a cache memory for temporarily storing data read/written from/to logical volumes VOLs. The controller 41 controls the input/output of data between the information providing servers 4 and disk devices 40.

(1-2) Page Restore Function

The page restore function of each information providing server 4 in the network system 1 according to Embodiment 1 is explained.

(1-2-1) Outline of CDP Function and Journal Volume Backup Function

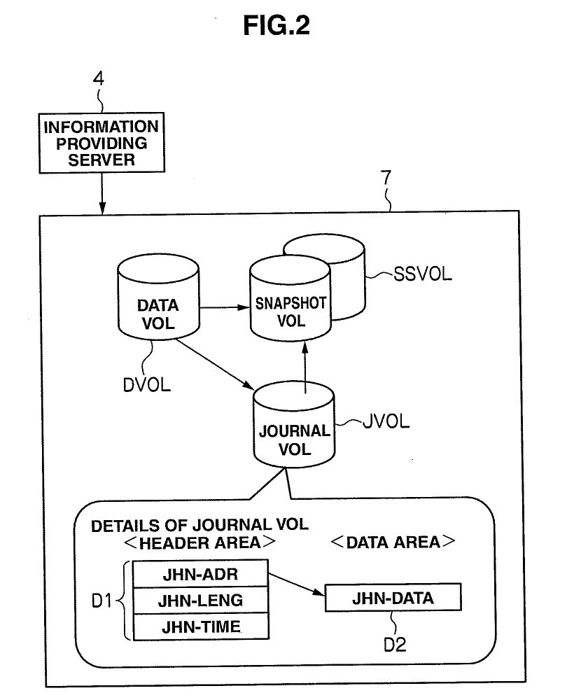

First, the CDP function and journal volume backup function of each storage apparatus 7 will be explained with reference to FIGS. 2-4. The CDP technique used in Embodiment 1 for realizing the CDP function is the technique disclosed in the foregoing Japanese Patent Laid-Open Publication No. 2005-18738, so only a brief explanation is given.

In this embodiment, when the controller 41 in the storage apparatus 7 receives a data write request and write target data from an information providing server 4, it stores the data at a designated address in a designated data volume DVOL and stores a journal in a journal volume JVOL.

As shown in FIG. 2, a journal is composed of: header information D1 composed of a data write destination address (‘JHN-ADR’), data length (‘JHN-LENG’), and the data update time (‘JHN-TIME’); and write target data D2 (‘JHN-DATA’). Incidentally, in Embodiment 1, the data update time is the time when the write request reached the storage apparatus 7. The header information D1 and write target data D2 in the journal are stored in a header area and data area in the journal volume JVOL, respectively.

The controller 41 in the storage apparatus 7 is capable of managing snapshots from a plurality of generations and creates a snapshot of the data volume DVOL at regular time intervals or when so requested by the information providing server 4. Differential data, which is obtained as a result of creating the snapshot and shows the difference between the current data volume DVOL and the data volume DVOL as of at the time when the snapshot was created, is stored in a snapshot volume SSVOL.

When the information providing server 4 designates a restore point-in-time and a restore target file, the controller 41 applies, to the snapshot whose creation time is prior and closest to the designated restore point-in-time, journals created during the time from the snapshot creation time to the restore point-in-time. Accordingly, the designated file can be restored to its state as of at the designated restore point-in-time.

The capacity of the journal volume JVOL is limited so only a certain number of journals can be stored in one storage apparatus 7. Therefore, in a conventional storage apparatus with the CDP function, when its journal volume JVOL is full, journals accumulated in the volume are all cleared or deleted beginning with the oldest one so that new journals can be stored.

However, with the conventional method, only journals created during a certain period of time (e.g., one year) can be stored and, as a result, there is a problem in that the data stored in the data volume DVOL cannot be restored to a state prior to that certain period of time.

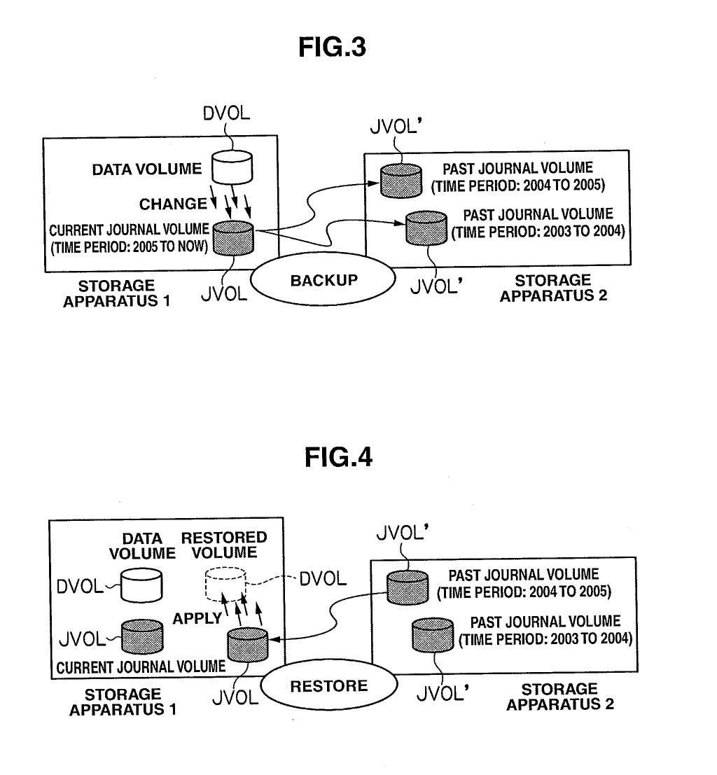

In order to solve this problem, the storage apparatus 7 according to Embodiment 1 has, as shown in FIG. 3, a journal backup function capable of backing up the journal volume JVOL when a certain number of journals are stored in the journal volume JVOL. With this function, the storage apparatus 7 can store an infinite number of journals and restore, using the data in a backup volume JVOL′, the data stored in the data volume DVOL to its state as of at any time in the past, as shown in FIG. 4.

Incidentally, when backups of the journal volume JVOL are continuously made, the cost for maintaining these journals can be expected to rise. In this network system 1, storage apparatuses 7, which are cheaper than the usual storage apparatuses 7, are used as backup destinations for the journal volume JVOL, and accordingly, the cost for maintaining the journals can be minimized.

(1-2-2) Outline of Page Restore Function

The page restore function will now be explained. As described above, a keyword search on a web search site provided by a web search service provider is performed based on the information as of at the time when the information collection unit 16 in the web search server 3 obtained the information from the Internet 5. Accordingly, there are some cases where, because a web page found in the keyword search has already been deleted, the client 2 cannot access that web page.

In the network system 1, the information providing server 4 has a page restore function capable of restoring, in response to a request from a client 2 seeking reference to a web page that has been already deleted, the content of the web page as of at the designated restore point-in-time (‘restore point-in-time’) using the CDP function of the storage apparatus 7 and presenting the restored web page to the client 2.

Recently, most web pages have links to other web pages provided by the same information provider or other information providers. In this situation, even if the content of a web page as of at an arbitrary point-in-time can be restored using the CDP function in the storage apparatus 7, the content of the web page of another information provider to which a link is provided on the restored web page cannot be restored.

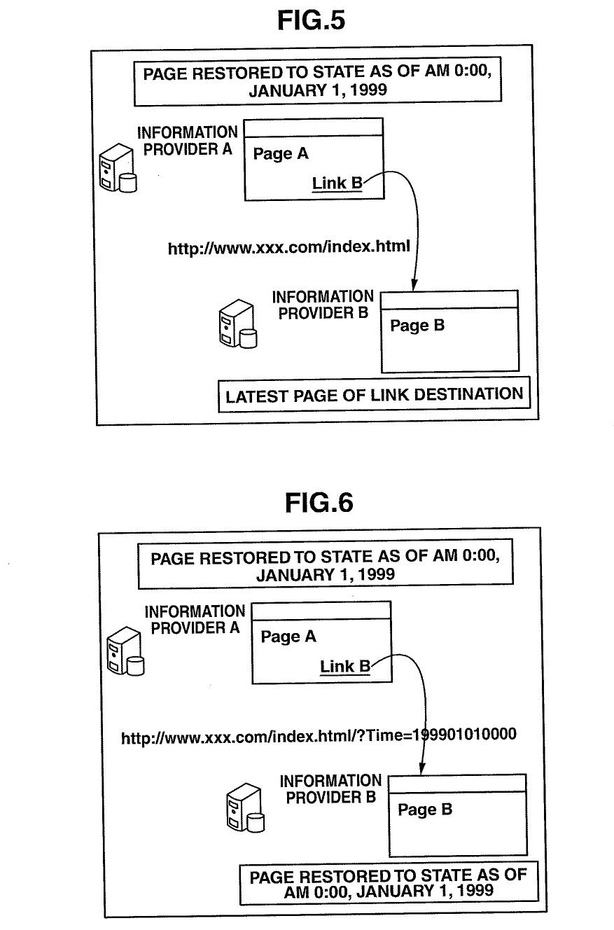

For example, as shown in FIG. 5, even when the web page (‘Page A’) of the site provided by the information provider A as of at 0:00 am, Jan. 1, 1999—which is a page requested by a user—is restored, when the user makes an attempt to access the site of an information provider B via the link provided on the restored web page, the current web page (as of year 2006), is presented to the user, not the web page as of at 0:00 am, Jan. 1, 1999. The user may find no problems and be satisfied with this result, but sometimes it is desired that the relevant information also be restored to the state as of at the same point in time.

In the network system 1 according to Embodiment 1, the operation system described below is applied in the information providing server 4 so that, when a web page is restored to its state as of at a designated restore point-in-time, all the web pages (including the web pages provided by different information providers) the user will access later are restored to their states as of at the same designated restore point-in-time, as shown in FIG. 6.

First, web page URLs will be explained. A web page URL is usually expressed in the form ‘www.abc.com/index.html.’ The ‘www.abc.com’ part is a site address and the ‘index.html’ part is a web page address. A fixed address that does not include ‘?’ is called a ‘static URL.’ A variable address that includes ‘?,’ e.g., ‘www.abc.com/index.html/search?keyword=aaa&la=ja,’ is called a ‘dynamic URL.’ Dynamic URLs are used in content for fetching necessary data from databases when requested by users, creating files in real-time on a server using languages such as ASP (Active Server Pages), PHP, or CGI (Common Gateway Interface), and sending them to a browser.

In Embodiment 1, a dynamic URL is used when access is made from a restored web page to a web page of a site provided by another information provider, to which a link is provided on the restored web page, and this dynamic URL is created by adding the designated restore point-in-time to the static URL of the link source web page. The information providing server that receives the dynamic URL restores the link destination web page to its state as of at the publication date and time set in the dynamic URL or to its state as of at the designated restore point-in-time, and presents it to the client.

Usually, as shown in the FIG. 5 example, when access is made from the web page provided by the information provider A to a site provided by another information provider B, the static URL (e.g., ‘www.bbb.com/index.html’) of the destination site is used. However, with the static URL, one can never know which point-in-time's ‘index.html’ is displayed. In most cases, the latest information is displayed.

In Embodiment 1, when accessing from the web page of the information provider A that has been restored to its state as of at a certain restore point-in-time to the web page of a site of another information provider B, a dynamic URL, for example, ‘www.bbb.com/index.html?Time=199901010000’—created by adding the restore point-in-time (‘?Time=199901010000’) of the link source web page to the static URL of the link destination web page—is used. The information provider B, having received the dynamic URL, restores ‘index.html’ as of at ‘0:00 am, Jan. 1, 1999’ using the CDP time restore function.

By using a dynamic URL including the restore point-in-time of an link source web page, the information public at the same time as the link source web page is provided on the link destination web page. Moreover, when access is again made from this secondarily-restored web page to another link destination, the link destination web page as of at the same restore point-in-time can be provided to the user, by using the URL including the time information. Consequently, all the linked web pages can be restored to their states as of at the same restore point-in-time.

(1-2-3) Structures of Tables

In the network system 1 according to Embodiment 1, each information providing server 4 includes a restore management table 30, history management table 31, and volume management table 32 as means for realizing the page restore function.

Each information providing server 4 creates a restore management table 30 for each of its sites, in order to manage the files (web pages, documents, images and voices) provided on the site.

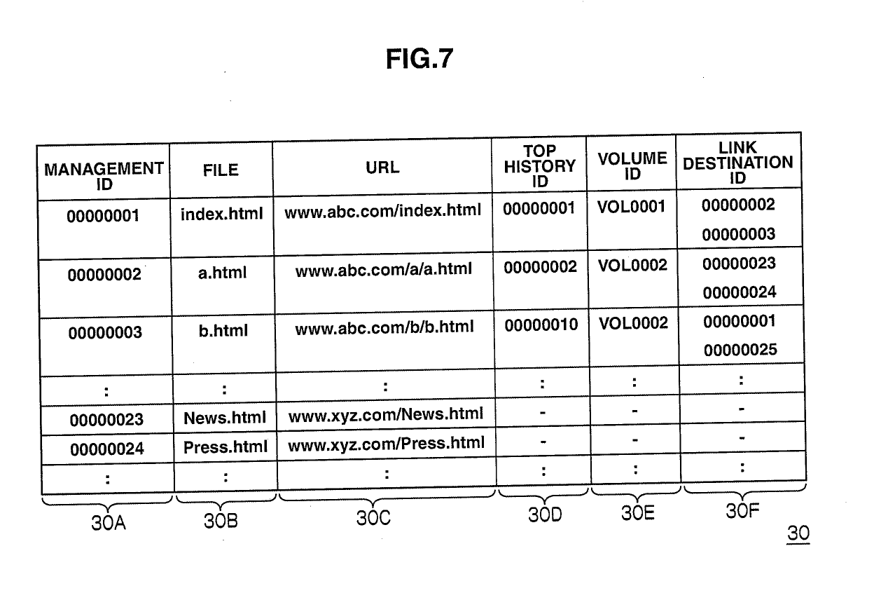

As shown in FIG. 7, the restore management table 30 is composed of a ‘management ID’ section 30A, ‘file name’ section 30B, ‘URL’ section 30C, ‘top history ID’ section 30D, ‘volume ID’ section 30E, and ‘link destination ID’ section 30F. The ‘management ID’ section 30A, ‘file name’ section 30B, and ‘URL’ section 30C respectively store the unique management IDs assigned to the files, file names, and URLs of the files.

The ‘top history ID’ section 30D stores the history IDs for the files, the history IDs corresponding to the IDs in the history management table 31, which will be described later. The ‘volume ID’ section 30E stores the IDs (volume IDs) of the logical volumes VOLs in the storage apparatuses 7 storing the files. The ‘link destination ID’ section 30F stores the management IDs of the relevant files linked to the subject files from among the files provided in the site.

In the example shown in FIG. 7, regarding the site ‘www.abc.com’ managed by one of the information providing servers 4, the file ‘index.html’ is stored in the logical volume VOL having the volume ID ‘VOL0001’ and links are provided on this file to the files ‘a.html’ and ‘b.html.’

Incidentally, the restore management table 30 also stores the files (e.g., ‘News.html’ and ‘Press.html’ in FIG. 7) of an external site, to which links are provided on the web pages of the site of the information providing server 4. Here, because these files are managed by another information providing server 4, no relevant information is stored for these files in the ‘top history ID’ section 30D, ‘volume ID’ section 30E, or ‘link destination ID’ section 30F.

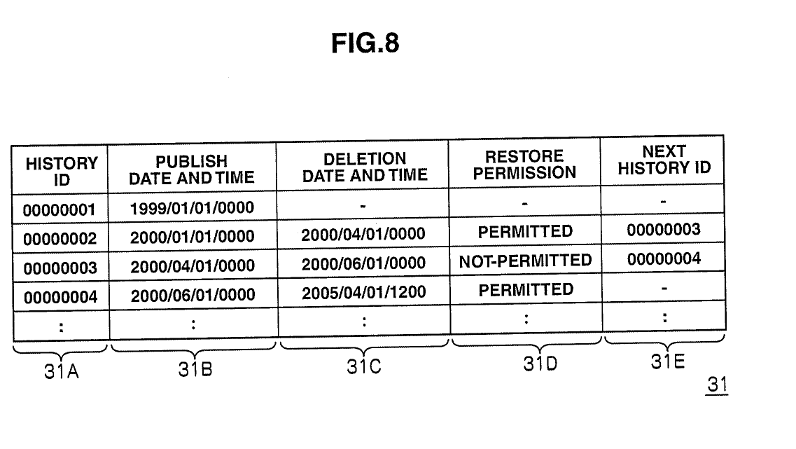

Meanwhile, the history management table 31 is for managing and monitoring the deletions and updates of the information provided by the information provider and is composed of a ‘history ID’ section 31A, ‘publish date and time’ section 31B, ‘deletion date and time’ section 31C, ‘restore permission’ section 31D, and ‘next history ID’ section 31E, as shown in FIG. 8.

The ‘history ID’ section 31A stores the history IDs assigned to the files registered in the restore management table 30. The ‘publish date and time’ section 31B stores the dates and times the files were put on the web pages of the sites provided by the information providing server 4. The ‘deletion date and time’ section 31C stores the dates and times the files are deleted from the web pages.

The ‘restore permission’ section 31D stores the information regarding whether or not the information provider permits the restoring of the file to the state as of at the time when they were put on the web pages, i.e., ‘permitted’ or ‘not-permitted’ is entered. The ‘next history ID’ section 31E stores, when the files are updated, the history IDs of the updated files in the restore management table 30.

In the example shown in FIG. 8, one can know that, with reference also to FIG. 7, the file ‘index.html’ has not been changed since 0:00 am, Jan. 1, 1999 to the present time. The file ‘a.html’ had been on the Internet from 0:00 am, Jan. 1, 1999 to 0:00 am, Apr. 1, 2000 and the restoring of the file to its state as of at any time within that period of time is permitted.

Also, it can be understood from the history management table 31 that the file ‘a.html’ has been updated both at 0:00 am, Apr. 1, 2000 and 0:00 am, Jun. 1, 2000 and the restoring of the file to its state as of at any time from 0:00 am, Jun. 1, 2000 to 0:00 am, Apr. 1, 2005 is permitted but the restoring of the file to its state as of at any time 0:00 am, Apr. 1, 2000 to 0:00 am, Jun. 1, 2000 is not permitted.

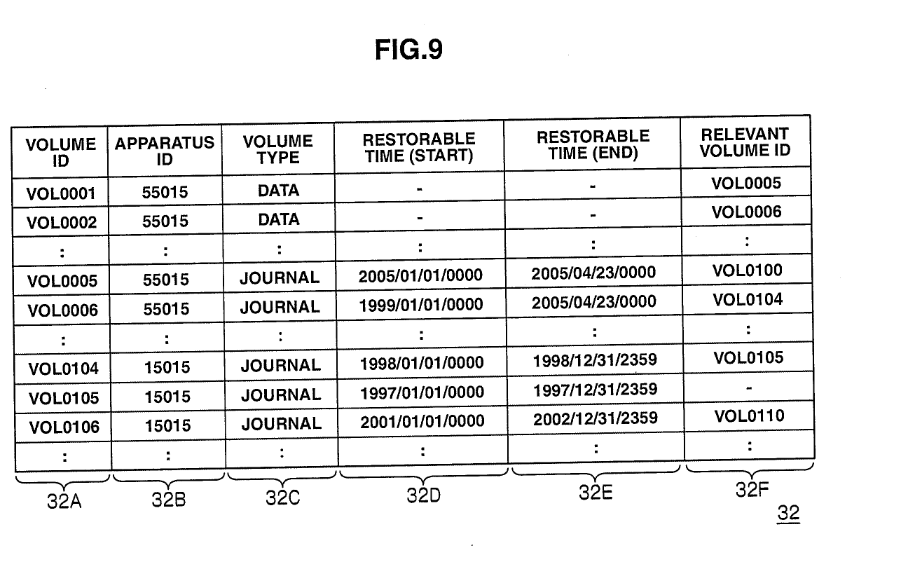

Meanwhile, the volume management table 32 is for managing the logical volumes VOLS provided in the storage apparatuses 7 and is composed of a ‘volume ID’ section 32A, ‘apparatus ID’ section 32B, ‘volume type’ section 32C, ‘restorable time (start)’ section 32D, ‘restorable time (end)’ section 32E, and ‘relevant volume ID’ section 32F, as shown in FIG. 9.

The ‘volume ID’ section 32A stores the volume IDs assigned to the logical volumes VOLs, and the ‘apparatus ID’ section 32B stores the IDs assigned to the storage apparatuses 7 where the logical volumes VOLs are provided. The ‘volume type’ section 32C stores the types of the logical volumes VOLs (data volumes, snapshot volumes, or journal volumes).

The ‘restorable time (start)’ section 32D and ‘restorable time (end)’ section 32E store the start points and end points of the periods during which the data stored in the logical volumes VOLs can be restored to states as of at any time.

The ‘relevant volume ID’ section 32F stores the IDs of the relevant logical volumes VOLs associated to the subject logical volumes VOLs. More precisely, if a subject logical volume VOL is a data volume, the ID of the journal volume storing journals created when a file stored in the subject data volume was updated is entered in the ‘relevant volume ID’ section 32F. If a subject logical volume VOL is a journal volume, the ID of a backup volume for the subject journal volume or the ID of the previous-generation backup volume is entered in the ‘relevant volume ID’ section 32F.

In the example of FIG. 9, one can know that the logical volume VOL ‘VOL0005’ is a journal volume provided in the storage apparatus 7 having the apparatus ID of ‘55015.’ This logical volume VOL (journal volume) stores the journals for the information stored in the logical volume VOL (data volume) ‘VOL0001’ and, with these journals, the information from 0:00 am, Jan. 1, 2005 to 0:00 am, Apr. 23, 2005 can be restored.

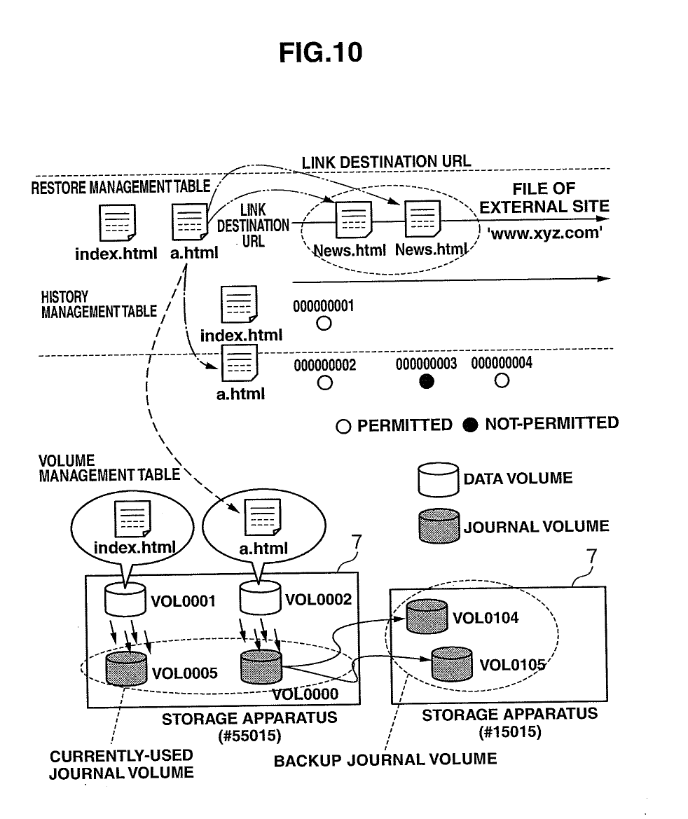

The relationships between the restore management table 30, history management table 31, and volume management table 32 in the information providing server 4 are shown in FIG. 10. The upper part of FIG. 10 shows the relationships between the files (‘index.html,’ ‘a.html,’ ‘www.xyz.com/News.html,’ and ‘www.xyz.com/Press.html’) registered in the restore management table 30. The center part shows that the update history of, from among the foregoing files, the files provided in the information providing server's own site (‘index.html’ and ‘a.html’) and the information whether or not restoring is permitted or not, are registered in the history management table 31.

The bottom part of FIG. 10 shows that the relationships between the data volumes storing the self-site files registered in the restore management table 30, the journal volumes storing journals created when the information in the data volumes was updated, and the backup journal volumes for the foregoing journal volumes are stored in the volume management table 32.

(1-2-4) Page Restore Process Sequence

The sequence of steps in the process regarding the page restore function (‘page restore process’) according to Embodiment 1 is explained below.

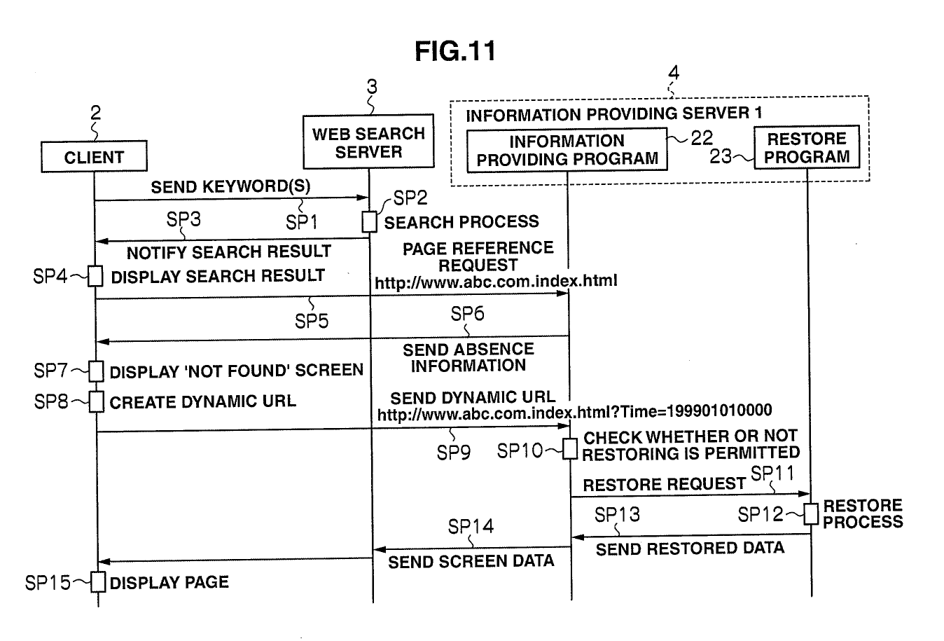

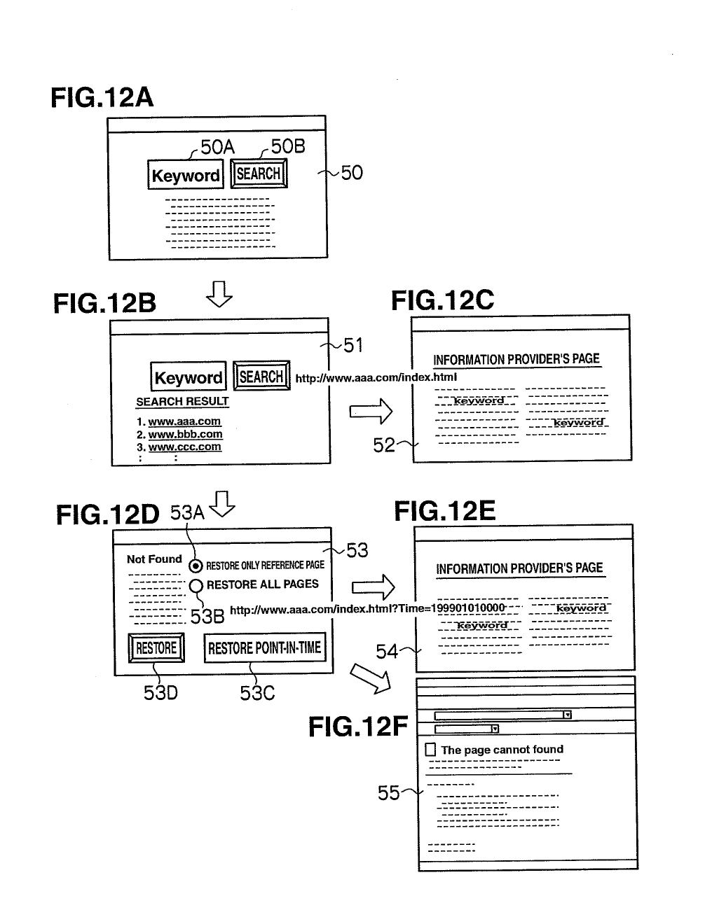

FIG. 11 is a diagram showing the sequence of steps in the page restore process. First, the user of a client 2 accesses a web search server 3. Then, a web search page 50 shown in FIG. 12 (A) is displayed on the client 2's display, based on the screen data sent from the web search server 3.

The user then inputs with the client 2 desired keywords in a keyword input box 50A on the web search page 50 and clicks the ‘search’ button 50B. The keywords input in the keyword input box 50A are then sent from the client 2 to the web search server 3 (SP1).

Having received the keywords, the web search server 3 searches for the file associated with the keywords from among the information registered in its search database 18 (FIG. 1) (SP2), and sends the screen data based on the search result to the client 2 (SP3). Accordingly, based on this screen data, a search result screen 51 shown in FIG. 12 (B), which shows the URLs (static URLs) of the relevant web pages is displayed on the client 2's display (SP4).

The user then selects, from among the web pages whose URLs are displayed on the search result screen 51, a desired web page. The client 2 then sends, to the relevant information providing server 4, a web page reference request (‘page reference request’), designating the reference destination URL (e.g., ‘www.abc.com/index.html’) shown on the search result screen 51 (SP5).

Having received the page reference request, the information providing server 4 sends the screen data for that web page using the information provider program 22 if the requested web page exists. Meanwhile, if the requested web page has been deleted and does not exist, the information providing server 4 sends the information that the requested web page does not exist (‘absence information’) to the client 2, using the information provision program 22 (SP6).

Accordingly, when the screen data is sent from the information providing server 4, the client 2 displays the web page 52 on its display based on the screen data, as shown in FIG. 12 (C). Meanwhile, if absence information is sent from the information providing server 4, it displays a screen (‘“Not Found” screen’) such as the one in FIG. 12 (D) on its display, showing the letters ‘Not Found,’ meaning that the access to the requested web page failed (SP7).

Then, if the user requests that the web page he/she intended to refer to be restored to its state as of at a desired point-in-time and selects a restore mode where only that web page is to be restored to its state as of at the desired restore point-in-time (‘first restore mode’), he/she selects a first radio button 53A, from among the first and second radio buttons 53A and 53B displayed on the ‘Not Found’ screen 53; inputs the desired restore point-in-time in a restore point-in-time designation box 53C; and clicks the ‘restore’ button 53D.

Meanwhile, if the user requests that that web page be restored to its state as of at a desired point-in-time and selects a restore mode where all the hit web pages are to be restored to their states as of at the desired restore point-in-time (‘second restore mode’), he/she selects the second radio button 53B from among the first and second radio buttons 53A and 53B displayed on the ‘Not Found’ screen 53; inputs the desired restore point-in-time in the restore point-in-time designation box 53C; and clicks the ‘restore’ button 53D.

Then, the client 2 creates a dynamic URL in a predetermined format, for example, ‘www.abc.com/index.html?Time=199901010000,’ which is created by attaching the character string ‘?Time=’ and the character string of the restore point-in-time input in the restore point-in-time designation box to the end of the static URL of the web page 53C (SP8), and sends it to the relevant information providing server 4 (SP9).

Having received the dynamic URL, the information providing server 4 checks whether or not restoring of the web page is permitted by referring to the history management table 31, using the information provider program 22 (SP10). If restoring of the web page is permitted, the information provider program 22 in the information providing server 4 sends a restore request to the restore program 23, designating the restore point-in-time, which is recognized from the dynamic URL (SP11).

Then, in response to the restore request and using the restore program 23, the information providing server 4 restores the designated web page as of at the designated restore point-in-time using the CDP technique (SP12). When the web page restore process is complete, the screen data of the restored web page is sent from the restore program 23 in the information providing server 4 to the information provider program 22 (SP13).

Then, the information providing server 4 sends the screen data of the restored web page to the client 2 using the information provider program 22 (SP14). As a result, the restored web page as shown in FIG. 12 (E) is displayed on the client 2's display based on the screen data (SP15).

However, if it is judged in step SP10 that restoring of the web page is not permitted, the information providing server 4 notifies the client 2 to that effect. Then, a general ‘Not Found’ screen 55 as shown in FIG. 12 (F), which is different from the ‘Not Found’ screen 53 in FIG. 12 (D), is displayed on the client 2's display.

Incidentally, the sequence of steps so far is the same regardless of which of the first and second restore modes is selected as the restore mode.

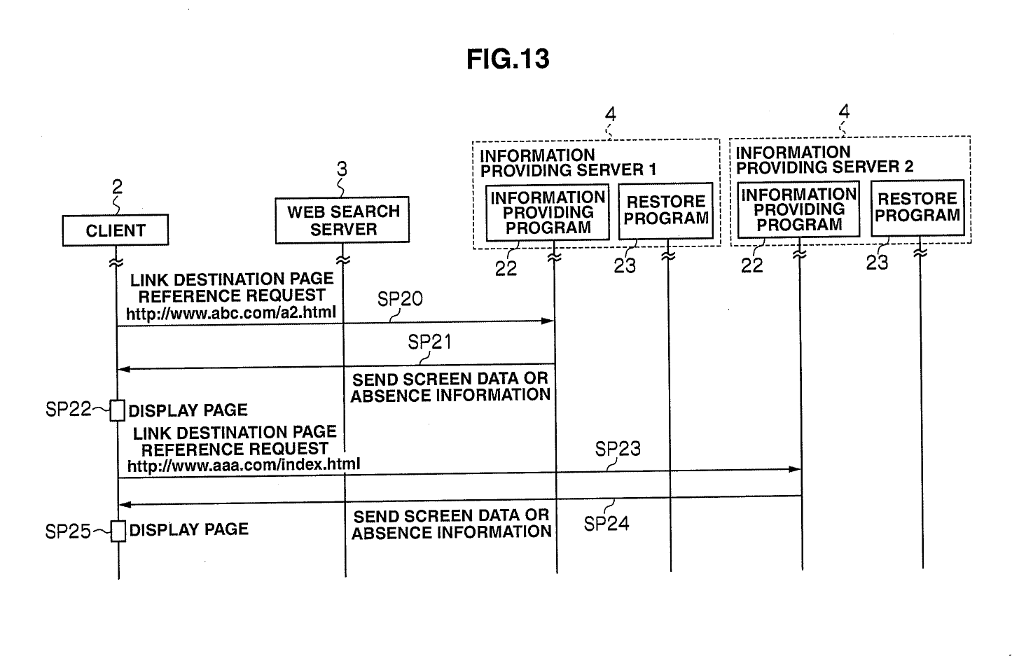

When the first restore mode is selected as a restore mode, in the situation where the restored web page shown in FIG. 12 (E) is displayed on the client 2's display, if the user manipulates the client 2 to travel from the current web page to another web page to which a link is provided on the current web page, the client 2 sends a page reference request to the relevant information providing server 4, designating as a reference destination the static URL of the destination web page (e.g., ‘www.abc.com/a2.html’ or ‘www.aaa.com/index.html’) but not designating a restore point-in-time, as shown in FIG. 13 (SP20, SP23).

Having received the page reference request, the information providing server 4 sends, if the requested web page exists, the screen data of the web page as of that moment to the client 2 using the information provider program 22 (SP21, SP24). Accordingly, based on the screen data, the web page as of the current time is displayed on the client 2's display (SP22, SP25).

If the requested web page does not exist, the information providing server sends absence information to the client 2 using the information provider program 22 (SP21, SP24). Based on this absence information, a general ‘Not Found’ screen 55 shown in FIG. 12 (F) is displayed on the client 2's display (SP22, SP25).

As long as the first restore mode is designated as a restore mode, each time the user makes a request to the client 2 to jump from the currently-referred web page to another web page for which a link is provided on the currently-referred web page, the same process is executed.

Meanwhile, when the second restore mode is designated as a restore mode, in the situation where the web page is displayed on the client 2's display as shown in FIG. 12 (E), if the user manipulates the client 2 to jump from the current web page to another web page for which a link is provided on the current web page, the client 2 creates a dynamic URL attaching the restore point-in-time etc. to the static address of the destination web page, and sends it to the relevant information providing server 4 (SP30, SP37).

Having received the dynamic URL, the information providing server 4 checks whether or not restoring of the designated web page is permitted (SP31, SP38), and if restoring is permitted, it restores the designated web page as of at the designated restore point-in-time (SP32-34, SP39-41), and sends the screen data of the restored web page to the client 2 (SP35, SP42). Then, based on the screen data, the restored web page is displayed on the client 2's display (SP36, SP43).

However, if restoring of the designated web page is not permitted, the information providing server 4 sends an error notice to the client 2. Then, a general ‘Not Found’ screen 55 shown in FIG. 12 (F) is displayed on the client 2's display.

The same process is executed each time the user manipulates the client 2 to travel from the currently-referred web page to another web page to which a link is provided on the currently-referred web page, as long as the second restore mode is designated as a restore mode.

(1-2-5) Page Restore Function-Related Process Performed by CPU in Information Providing Server

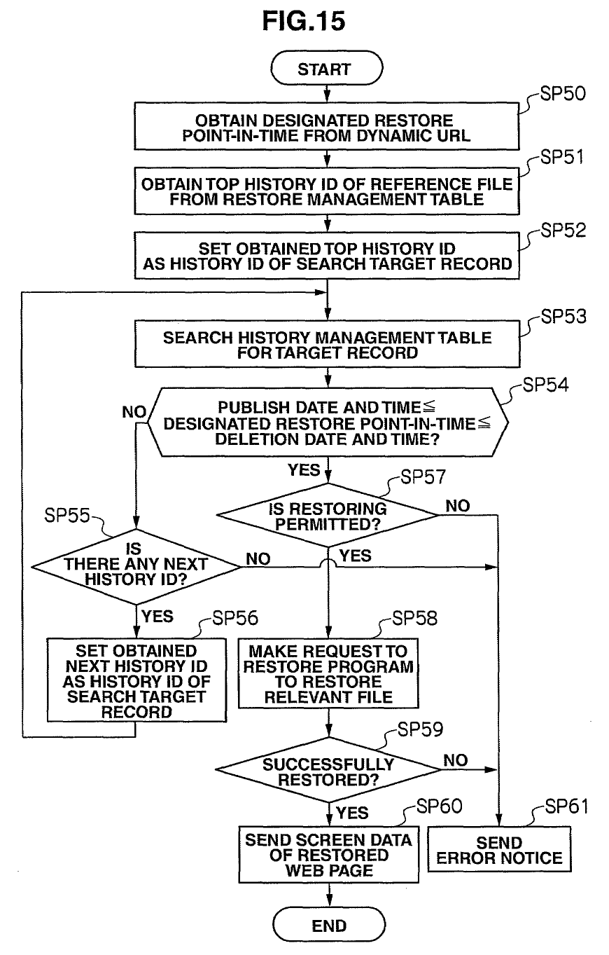

FIG. 15 is a flowchart of the process, from among the processes the CPU 20 (FIG. 1) in the information providing server 4 performs regarding the page restore function, performed when a dynamic URL is sent from a client 2. The CPU 20 executes the process shown in FIG. 15 (‘first restore process’) using the information provision program 22.

When the CPU 20 receives a dynamic URL where the URL of a restore target web page and a restore point-in-time are designated from a client 2, it starts the first restore process shown in FIG. 15, where it first obtains the designated restore point-in-time from that dynamic URL (SP50).

Then the CPU 20 refers to the restore management table 30 (FIG. 7), obtains the history ID of the file of the restore target web page used in the history management table 31 (FIG. 8) (SP51), and sets this history ID as the history ID of the search target file (SP52).

The CPU 20 then searches the history management table 31 for the record for the file assigned the foregoing history ID (SP53), and when the record is found, refers to the ‘publish date and time’ section 31B (FIG. 8) and ‘deletion date and time’ section 31C (FIG. 8) for that record; and judges whether or not the publish date and time of the search target file is prior to, and the deletion date and time of the same is after, the designated restore point-in-time (SP54).

If the judgment is negative (SP54: No), the CPU 20 judges whether or not any history ID is stored in the ‘next history ID’ section 31E (FIG. 8) of that record (SP55). If the judgment is negative (SP55: No), the CPU 20 sends an error notice, meaning that restoring is impossible, to the client 2 (SP61) and terminates the first restore process.

Meanwhile, if the judgment in step SP55 is positive (SP55: Yes), the CPU 20 sets the history ID as the history ID of a new search target file (SP56) and repeats the same search process as above (SP53-56 and return to SP53).

When the CPU 20 finds a record where the publish date and time of the search target file is prior to, and the deletion date and time of the same is after, the designated restore point-in-time (SP54: Yes), it refers to the ‘restore permission’ section 31D (FIG. 8) of that record and judges whether or not restoring of the file is permitted or not (SP57).

If the judgment is negative (SP57: No), the CPU 20 sends an error notice to the client 2 (SP61), and terminates the first restore process. Meanwhile, if the judgment is positive (SP57: Yes), the CPU 20 issues a restore request to the restore program 23 (FIG. 1), designating the file name of the target file, to request that the content of the file as of at the designated restore point-in-time be restored (SP58).

The CPU 20 then waits for a response from the restore program 23, and when it receives the data of the restored file, i.e., the screen data of the restored web page, from the restore program 23 (SP59: Yes), sends it to the client 2 (SP60), and terminates the first restore process.

Meanwhile, if the CPU 20 receives a restore-impossible notice, which will be described later, from the restore program 23 (SP59: No), it sends an error notice to the client 2 (SP61) and terminates the first restore process.

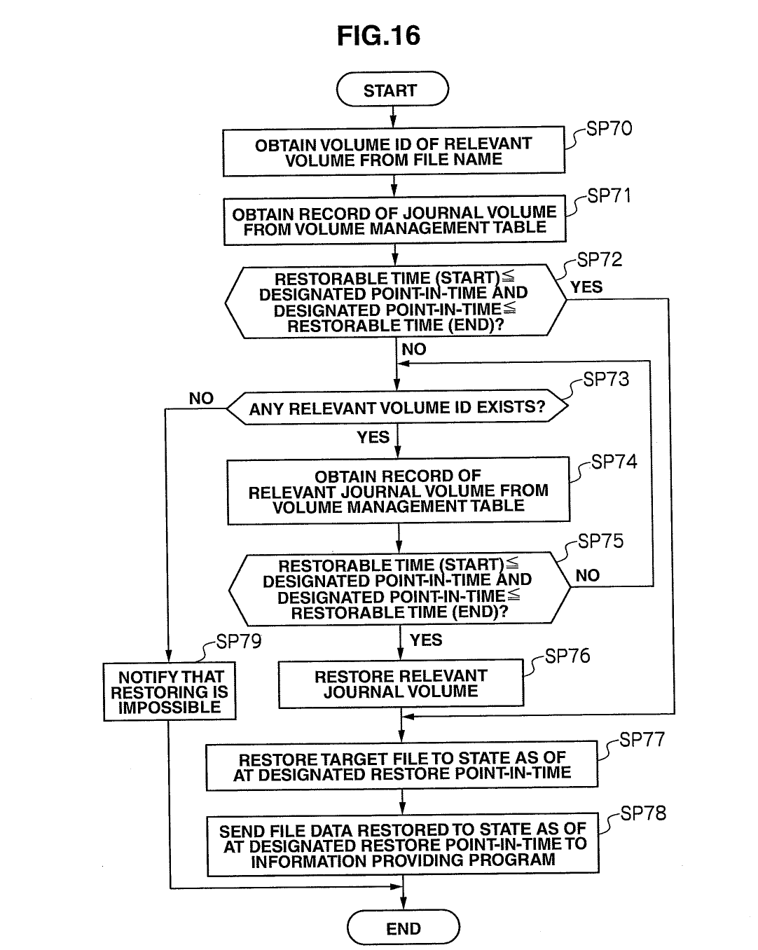

FIG. 16 is a flowchart showing the process performed by the CPU 20 when a restore request is issued in SP58 in the foregoing first restore process. The CPU 20 executes this process in FIG. 16 (‘second restore process’) based on the restore program 23.

When the CPU 20 issues a restore request to the restore program 23 using the information provision program 22, it starts the second restore process shown in FIG. 16, where it first refers to the restore management table 30 (FIG. 7) and volume management table 32 (FIG. 9), and obtains the volume ID of a logical volume VOL (journal volume) associated with the logical volume VOL (data volume) storing a restore target file (SP70).

The CPU 20 then searches the volume management table 32 for the record of the logical volume (journal volume) assigned the foregoing volume ID (SP71); refers to the ‘restorable time (start)’ section 32D (FIG. 9) and ‘restorable time (end)’ section 32E (FIG. 9) of the searched record; and judges whether or not the designated restore point-in-time falls within the period of time allowing restoring of the designated file based on the data (journal data) stored in the logical volume VOL (SP72).

If the judgment is positive (SP72: Yes), the CPU 20 restores the restore target file as of at the designated restore point-in-time using the journals stored in the logical volume VOL (journal volume) (SP77). The CPU 20 then sends the data of the restored file (i.e., the screen data of the restored web page) to the information provision program 22 (SP78) and terminates the second restore process.

Meanwhile, if the judgment in step SP72 is negative (SP72: No), the CPU 20 refers to the ‘relevant volume ID’ section 32F in the volume management table 32 (FIG. 9) and judges whether or not there is a relevant volume (SP73). If the judgment is negative (SP73: No), the CPU 20 notifies the information provision program 22 that restoring is impossible (SP79) and terminates the second restore process.

Meanwhile, when the judgment in SP73 is positive (SP73: Yes), the CPU 20 searches the volume management table 32 for the record of the relevant volume assigned the volume ID in the ‘relevant volume ID’ section 32F (FIG. 9) that was checked in step SP73 (SP74).

Then, when the CPU 20 finds the record for the relevant volume, it refers to the ‘restorable time (start)’ section 32D and ‘restorable time (end)’ section 32E (FIG. 9) of that record, and judges whether or not the designated restore point-in-time falls within the period of time allowing restoring of the restore target file using the data (journal data) stored in the relevant logical volume VOL (SP75).

If the judgment is negative (SP75: No), the CPU 20 repeats the same process (SP73-75 and return to SP73) until the judgment in SP73 is negative or the judgment SP75 is positive 75.

When the CPU 20 finds the logical volume VOL (journal volume) storing the journals that can be used for restoring the restore target file as of at the designated restore point-in-time (SP75: Yes), it restores, if necessary, that logical volume VOL (SP76).

The CPU 20 then restores the restore target file to its state as of at the designated restore point-in-time using the journals stored in the restored logical volume VOL (SP77), and sends the data of the restored file (i.e., the screen data of the restored web page) to the information provision program 22 (SP78). The CPU 20 then terminates the second restore process.

(1-3) Effects of Embodiment 1

As described above, with the network system 1 according to Embodiment 1, the client 2 creates a dynamic URL by attaching a desired restore point-in-time to the static URL of a web page that has been deleted from the Internet 5, and sends it to the relevant information providing server 4 and the information providing server 4 restores, based on the received the dynamic URL, the target web page to its state as of at the designated restore point-in-time and sends it to the client 2. Accordingly, the user can obtain the information that has been deleted from the Internet 5 and so the work of searching by the user can be enhanced. Consequently, the convenience of the Internet 5 can be improved to a great extent.

### (2) Embodiment 2

In FIG. 1, the reference numeral 60 indicates the overall network system according to Embodiment 2. The network system 60 is structured the same as the network system 1 according to Embodiment 1 except that the web page restore process is performed without the user having to designate a restore point-in-time.

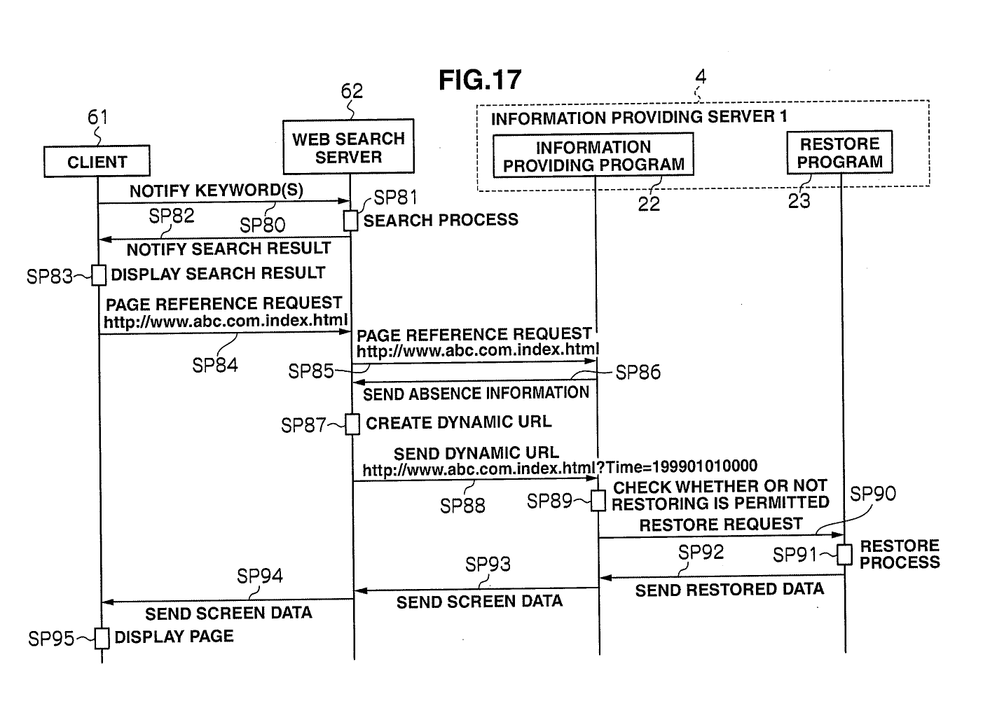

FIG. 17 is a diagram showing the sequence of steps in the page restore process in the network system 60. In FIG. 17, SP 80-83 are the same as SP1-4 in the page restore process according to Embodiment 1, which was explained with reference to FIG. 11.

After these steps, when the user selects a desired web page from among the web pages listed on the search result screen displayed on the client 61's display, the client 61 sends a page reference request to the relevant web search server 62, designating the selected web page as the reference destination (SP84).

Having received the page reference request, the web search server 62 sends the page reference request to the relevant information providing server 4 using the web search program 63 (SP85). If the requested web page exists, the information providing server 4 sends the screen data of the web page to the web search server 62 using the information provider program 22. If the requested web page has already been deleted and does not exist, the information providing server 4 sends absence information, which indicates that the requested web page does not exist, to the web search server 62 using the information provision program 22 (SP86).

Having received the screen data from the information providing server 4, the web search server 62 sends it to the client 61. Consequently, the web page the user selected on the search result screen is displayed on the client 61's display based on the screen data.

Meanwhile, if the web search server 62 receives the absence information from the information providing server 4, it creates a dynamic URL by attaching the time when the information providing server 4 collected the information for the web page to the static URL of the web page (SP87) and sends it to the information providing server 4 (SP88).

Having received the dynamic URL, the information providing server 4 judges, using the information provision program 22, whether or not restoring of the web page is permitted by referring to the history management table 31 (FIG. 8) (SP89). If restoring of the web page is permitted, the information provision program 22 in the information providing server sends a web page restore request to the restore program 23 and the restore program 23 restores the content of the web page as of at the collection time of the information for the web page (SP91).

The screen data of the web page obtained in the restore process is then sent from the restore program 23 to the information provision program 22 (SP92) and sent to the web search server (SP93).

Having received the screen data, the web search server 62 transfers it to the client 61 (SP94). Consequently, the above-restored web page is displayed on the client 61's display based on the screen data (SP95).

With the network system 60 according to Embodiment 2, when the web page the user selects on the search result screen 51 (FIG. 12 (B)), which is displayed as a result of the search based on the user-designated keywords, does not exist, the web search server 62 makes a restore request (i.e., creates a dynamic URL and sends it to the relevant information providing server), so the user can refer to the restored web page without having to designate the restore date and time. Accordingly, compared to the network system 1 in Embodiment 1, the work of searching by the user can be enhanced more.

### (3) Embodiment 3

In FIG. 1, the reference numeral 70 indicates the overall network system according to Embodiment 3. The network system 70 is structured the same as the network system 1 according to Embodiment 1 except that, when an information providing server 4 restores a web page to its state as of at a certain restore point-in-time, before a client 2 makes a page reference request, all the web pages to which links are provided on the restored web page are restored in advance to their states as of at the same restore point-in-time as the link source web page.

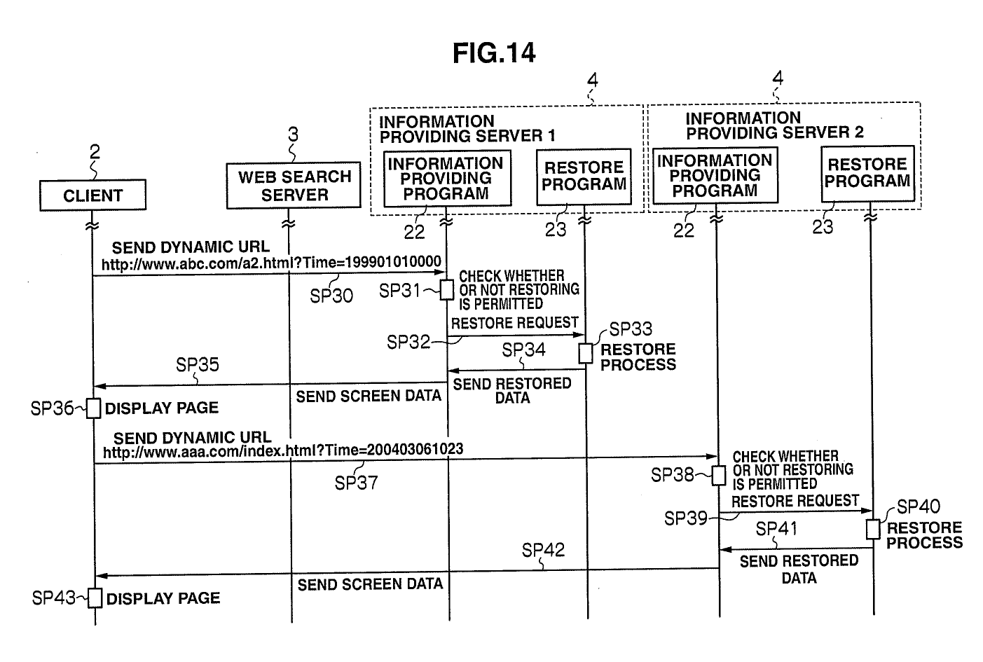

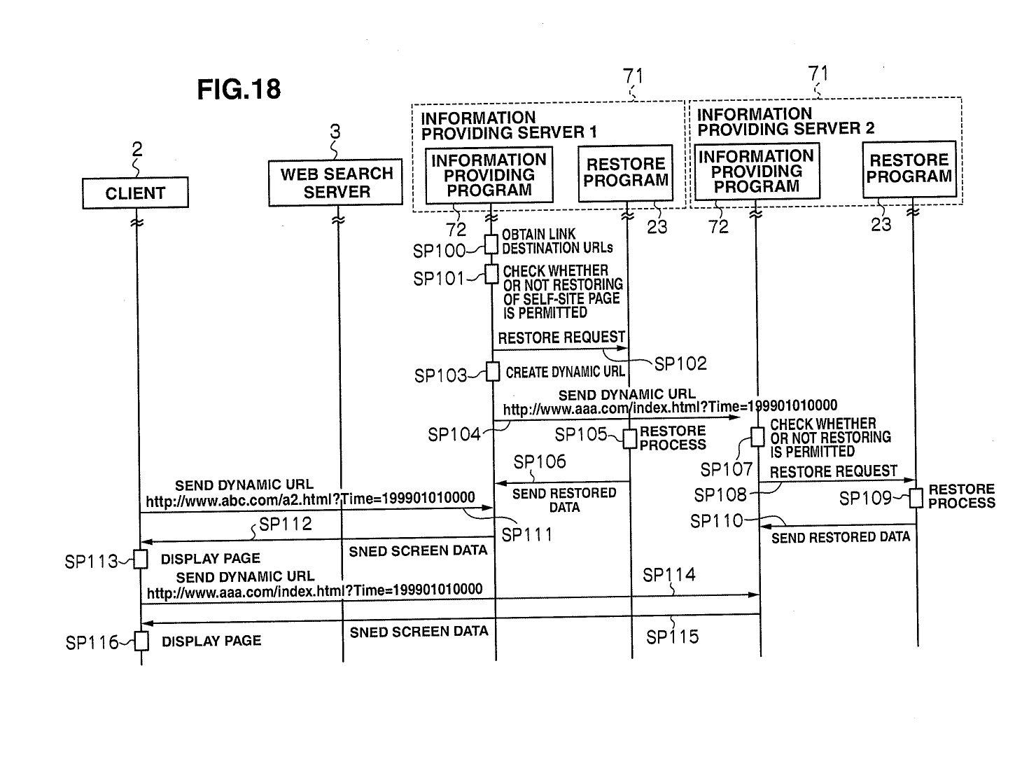

FIG. 18 is a diagram showing the sequence of steps in the process, from among the processes performed in the network system 70 according to Embodiment 3, performed in place of the process shown in FIG. 14. Incidentally, the processes other than this process are the same as those in network system 1 according to Embodiment 1.

With the network system 70, when the steps in the sequence in FIG. 11 are over, the information providing server 71 obtains, based on the information provision program 72, the URLs of all the web pages to which links are provided on the restored web page (SP100).

The information providing server 71 then judges, for the web page of its own site from among the link destination web pages whose URLs were obtained in SP100, whether or not restoring to the state as of at the restore point-in-time of the link source web page is permitted or not, by referring to the restore management table 30 (FIG. 7) and history management table 31 (FIG. 8) (SP101).

If it is permitted, the information provision program 72 in the information providing server 71 sends a restore request to the restore program 23 while setting a restore point-in-time to the restore point-in-time of the link source web page (SP102). Having received the restore request, the restore program 23 restores the web page as of at the designated restore point-in-time (SP105) and sends the screen data of the restored web page to the information provision program 72 (SP106).

Meanwhile, for a web page provided by another information provider from among the link destination web pages whose URLs were obtained in SP100, the information providing server 71 creates a dynamic URL by attaching, as a designated restore point-in-time, the restore point-in-time of the link source web page to the URL of that web page (SP103) and sends it to the relevant information providing server 71 (SP104).

Having received the dynamic URL, the information providing server 4 judges, based on the information provision program 72, whether or not restoring of the designated web page to its state as of at the designated restore point-in-time is permitted by referring to the restore management table 30 (FIG. 7) and history management table 31 (FIG. 8) (SP107). If it is permitted, the information provider program 72 in the information providing server 71 sends a restore request to the restore program 23 and the restore program 23 restores the web page to its state as of at the designated restore point-in-time in response to the request (SP109). Then, the screen data of the restored web page is sent from the restore program 23 to the information provision program 72 (SP110).

Later, when the user inputs to the client 2a request to access another web page to which a link is provided on the firstly-restored web page, the client 2 creates a dynamic URL by attaching the restore point-in-time of the link source web page to the URL of the link destination web page and sends it to the relevant information providing server (SP111, SP114).

Then the information providing server 71 sends the screen data of the pre-restored web page to the client 2 based on the information provision program 72 (SP112, SP115). Consequently, the web page of the link destination web page that has been restored to its state as of at the same restore point-in-time as the link source web page is displayed on the client 2's display, based on the display screen (SP113, SP116)

Incidentally, when the information providing server 71 sends the screen data of the secondly-restored link destination web page to the client 2, it obtains the URLs of all the web pages to which links are provided on the secondly-restored web page and executes the same process from steps SP100-110. By doing so, with the network system 70, the user can always refer to web pages that are restored to their state as of at the same designated restore point-in-time as the firstly-restored web page.

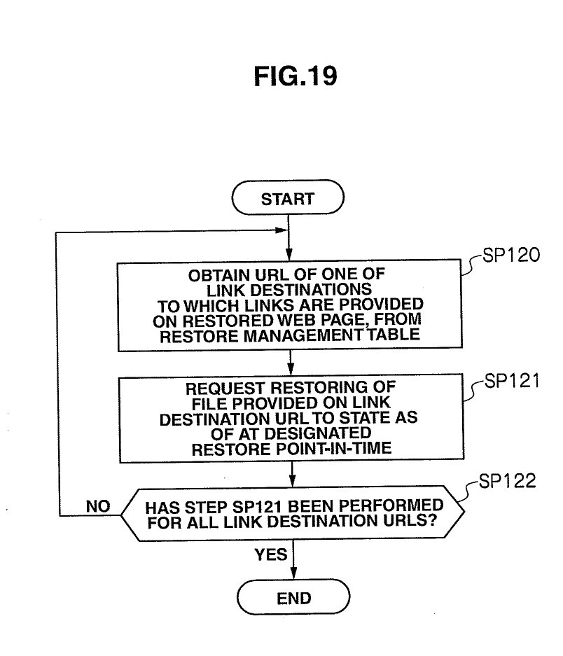

FIG. 19 is a flowchart of the process, from among the processes performed by the CPU 20, explained in relation to FIG. 18, based on the information provision program 72 in the information providing server 71.

When the first restore process described with reference to FIG. 15 is over, the CPU 20 starts the pre-restore process shown in FIG. 19, where it first refers to the restore management table 30 (FIG. 7) and obtains the URL of one of the web pages to which links are provided on the restored web page (SP120).

In the information providing server 71, when the URL obtained in SP120 is the web page of its own site, the CPU 20 judges whether or not restoring of the web page to its state as of at the same designated restore point-in-time as that of the link source web page is permitted and, if it is permitted, the CPU 20 sends a restore request to the restore program 23 in the same information providing server 71. Meanwhile, when the URL obtained in SP120 is of a web page provided by another information providing server 71, the CPU 20 creates a dynamic URL by attaching the designated restore point-in-time of the link source web page to the URL and sends it to the relevant information providing server 71 (SP121).

The CPU 20 then refers to the restore management table 30 (FIG. 7); judges whether or not SP121 has been performed for the URLs of all the link destinations to which links are provided on the restored web page (SP122); and, if the judgment is negative (SP122: No), returns to SP120 and repeats the same steps (SP120-122, and return to SP120).

When the CPU 20 finishes executing SP121 for the URLs of all the link destinations to which links are provided on the restored web page (SP122: Yes), it terminates the pre-restore process.

With the network system 70 according to Embodiment 3, because the web pages to which links are provided on a firstly-restored web page are restored to their state as of at the same restore point-in-time as that of the firstly-restored web page before a client 2 makes a reference request, the user can jump to a link destination/restored web page promptly. Accordingly, the performance of the search improves for the user and the convenience of the Internet 5 can also be improved more.

### (4) Other Embodiments

Embodiments 1-3 were explained for the case where this invention is applied in the network systems 1, 60 and 70, which are structured as shown in FIG. 1, however, this invention is not limited to this case and can also be applied in network systems having other structures.

Embodiments 1-3 were also explained for the case where, when making a request to an information providing server 4 or 71 to restore a web page, a dynamic URL (second address information) is created by attaching a designated restore point-in-time in a format such as ‘?Time=199901010000’ to the static URL (first address information) of the restore target web page, however, this invention is not limited to this case and the dynamic URL may also be in other types of formats.

Moreover, Embodiments 1-3 were explained for the case where the communication devices that receive information from the information providing servers (4, 71) are the client (2, 61) and web search server (3, 62), however, this invention is not limited to this case and other types of communication devices may also be used.

Furthermore, Embodiments 1-3 were explained for the case where a restore target is a web page, however, this invention is not limited to this case and a restore target may also be various types of information, such as documents, images, or voices.

Embodiments 1-3 were also explained for the case where, when traveling from an information provider's web page that has been restored to its state as of at a certain point in time to the web page of another information provider, the client 2 or web search server 62 creates a dynamic URL by using the restore point-in-time of the link source web page. However, this invention is not limited to this case and, in place of the client 2 or web search server, the information providing server may create the dynamic URL when restoring the link source web page to its state as of at the designated restore point-in-time, and display it as the URL of a web page to which a link is provided on the restored web page.

Further, Embodiments 1-3 were explained for the case where the first network 5 connecting the client (2, 61), web search server (3, 62) and information providing server (4, 71) is the Internet, however, this invention is not limited to this case and it can be widely applied to cases where the first network 5 is a LAN (Local Area Network) or a dedicated line.

This invention can be widely applied in information provision systems having structures where communication devices and information providing servers that provide information in response to requests from the communication devices are connected to one another via a network.

What is claimed is:

1. An information provision system where a communication device and information providing server that provides information in response to a request from the communication device are connected via a network,
wherein the communication device creates second address information by adding a desired restore point-in-time to first address information which indicates the location of access target information on the network, and sends it to the information providing server via the network; and
the information providing server restores, based on the received second address information, the target information to its state as of at the designated restore point-in-time and sends it to the communication device.

2. The information provision system according to claim 1, wherein the communication device creates second address information by adding an externally input restore point-in-time to the first address information for the access target information on the network.

3. The information provision system according to claim 1,
wherein the communication device is a search server that collects pieces of information existing on the network, creates a database where the first address information for the pieces of information is registered and, in response to an external request, searches the database for a piece of information on the network, and
the communication device creates second address information by adding, as a restore point-in-time, the time when it collected the information from the information providing server to the first address information for the access target information on the network.

4. The information provision system according to claim 1, wherein the information providing server restores, when another piece of information to which a link is provided in the restored information is its own information, the other piece of information to its state as of at the restore point-in-time designated by the second address information.

5. The information provision system according to claim 1, wherein the information providing server further creates, when another piece of information to which a link is provided in the restored information is provided by another information providing server, second address information by adding the restore point-in-time designated by the previous second address information to the first address information indicating the location of the other information in the network, and sends it to the other information providing server via the network.

6. The information provision system according to claim 1, wherein the information providing server obtains a snapshot of a first volume storing the information at regular or irregular time intervals, the snapshot being a data image of the first volume as of at a certain point in time; stores a journal consisting of a piece of update history information each time the information stored in the first volume is updated; and, when it receives second address information, restores the information to its state as of at the designated restore point-in-time using the snapshot and journal.

7. The information provision system according to claim 6, wherein the information providing server stores the journal in a second volume and creates, in accordance with the number of journals accumulated in the second volume, a backup of the second volume as necessary.

8. The information provision system according to claim 1 wherein the access target information is a web page.

9. An information provision method for a network system where a communication device and information providing server that provides information in response to a request from the communication device are connected to each other via a network, comprising:
a first step where the communication device creates second address information by adding a desired restore point-in-time to first address information, which indicates the location of access target information on the network and sends it to the information providing server via the network; and
a second step where the information providing server restores, based on the received second address information, the target information to its state as of at the designated restore point-in-time and sends it to the communication device.

10. The information provision method according to claim 9, wherein, in the first step, the communication device creates second address information by adding an externally input restore point-in-time to the first address information for the access target information on the network.

11. The information provision method according to claim 9,
wherein the communication device is a search server that collects pieces of information existing on the network, creates a database where the first address information for the pieces of information is registered and, in response to an external request, searches the database for a piece of information on the network, and
in the first step, the communication device creates second address information by adding, as a restore point-in-time, the time when it collected the information from the information providing server to the first address information for the access target information on the network.

12. The information provision method according to claim 9, wherein, in the second step, the information providing server restores, when another piece of information to which a link is provided in the restored information is its own information, the other piece of information to its state as of at the restore point-in-time designated by the second address information.

13. The information provision method according to claim 9, wherein, in the second step, the information providing server further creates, when another piece of information to which a link is provided in the restored information is provided by another information providing server, second address information by adding the restore point-in-time designated by the previous second address information to the first address information indicating the location of the other information in the network, and sends it to the other information providing server via the network.

14. The information provision method according to claim 9, wherein,
the information providing server obtains a snapshot of a first volume storing the information at regular or irregular time intervals, the snapshot being a data image of the first volume as of at a certain point in time and, each time the information stored in the first volume is updated, it stores a journal consisting of a piece of update history information; and
in the second step, when the information providing server receives second address information, it restores the information to its state as of at the designated restore point-in-time using the snapshot and journal.

15. The information provision method according to claim 14, wherein the information providing server stores the journal in a second volume and creates, in accordance with the number of journals accumulated in the second volume, a backup of the second volume as necessary.

16. The information provision method according to claim 9, wherein the access target information is a web page.
